(19) United States
(12) Patent Application Publication
(10) Pub. No.: US 2006/0213453 A1
(43) Pub. Date: Sep. 28, 2006

(54) Exercise and entertainment apparatus for pet animals

(76) Inventor: Charles Paul Conrady, Durango, CO (US)

Correspondence Address: PEACOCK MYERS, P.C., 201 THIRD STREET, N.W., SUITE 1340, ALBUQUERQUE, NM, 87102, US

(21) Appl. No.: 11/376,028

(22) Filed: Mar. 14, 2006

Related U.S. Application Data
(60) Provisional application No. 60/594,142, filed on Mar. 14, 2005.

(51) Int. Cl. A01K 29/00

(52) U.S. Cl. 119/707

(57) ABSTRACT

An apparatus for simultaneous entertainment and physical exercise of a pet animal such as a dog or cat. An impeller rotates about a vertical axis between an upper hopper and a lower base. The hopper is configured to receive and hold a collection of projectiles, such as balls, which move by gravity from the hopper to be serially dispensed into an open-ended channel in the rotating impeller. The rotary motion of the impeller causes the balls to be ejected from either of the two open ends of the ejection channel, and generally horizontally away from the apparatus. Ejection of the balls occurs at random trajectories relative to the apparatus. The pet is entertained by chasing and possibly retrieving the serially ejected balls. Means and mechanisms are disclosed for powering the rotation of the impeller and for regulating the movement of the balls through the apparatus for ejection.

### CROSS-REFERENCE TO RELATED APPLICATIONS

This application claims the benefit of the filing of U.S. Provisional Patent Application Ser. No. 60/594,142, entitled Exercise and Entertainment Apparatus for Household Pets, filed on Mar. 14, 2005, and the specification thereof is incorporated herein by reference.

### BACKGROUND OF THE INVENTION

1. Field of the Invention (Technical Field)

The present invention relates to exercise and entertainment apparatus for pets, particularly but not limited to domestic dogs and cats, and specifically relates to an apparatus that encourages playful exercise by a pet by propelling a projectile to be chased by the animal.

2. Background Art

Pet exercise and amusement devices of the types described in the prior art have suffered from various drawbacks. In one example, the device no longer operates if the pet fails to return the projectile (such as a ball) to the device. In most instances, a prior art device shoots a projectile in a single direction and therefore lacks the capability of propelling a projectile in unexpected and unpredictable directions—unpredictability enhances the stimulation of the pet. In other examples, the operator of the device is required to be present throughout the operation of the device to load, aim, or activate the mechanism, which makes unattended operation impossible.

U.S. Pat. No. 4,267,799 to Bacon appears to disclose an animal training and amusement device including a ball-throwing means and a food dispensing means. Although the animal alone without human intervention can activate the unattended device, the device is incapacitated if the animal fails to return the ball to the device. Further, the Bacon device throws the ball in a single trajectory, so the stimulating element of surprise or unpredictability is lacking.

U.S. Pat. No. 6,684,819 to Lock similarly projects a ball-like member in a single direction only.

U.S. Pat. No. 5,529,016 to Lonsway discloses a dog toy for providing an unpredictable bounce to a ball. Although the Lonsway device offers an element of unpredictability, it requires attended operation by a human operator.

A device currently marketed as “WINGER ZINGER” product resembles a large slingshot. In operation, the user inserts a dead bird, such as a duck, pheasant or similar game fowl, in the pouch of the apparatus. The pouch is pulled back against the resistance of elastic members, and released thereby to project the fowl. The fowl is propelled through the air so that a trainer may teach a hunting dog to retrieve the dead bird. Another device marketed as the ETCH-MARC MAX product is a cannon-like device that uses either compressed air or an explosive propane mix as a propellant. Both the WINGER ZINGER product and the ETCH-MARC MAX device require a human attendant to reload, aim, and operate; further the direction of fire is readily anticipated by the animal, especially experienced dogs.

There is offered for sale a product marketed on the Internet at www.buygodoggo.com under the GO DOG GO brand, which device permits a number of projectiles such as balls to be projected periodically over an interval of time. However, the balls are expelled from a single, fixed location, so the element of unpredictability is entirely lacking for the pet.

Against the foregoing background, the present invention was developed.

### SUMMARY OF THE INVENTION (DISCLOSURE OF THE INVENTION)

An exercise and entertainment device for household pets comprises a base, a hopper, and an impeller. The base is an upright hollow housing, preferably constructed of plastic or other weatherproof, lightweight material. The base encloses at least a motor and the associated wiring and switching to link the motor to a power source, such as an on-board battery. Alternative embodiments may include more sophisticated electronic elements, such as programmable controllers and radio or infrared receivers, within the base or elsewhere on the apparatus.

The hopper is an upright shell, preferably also constructed of plastic or other durable waterproof, lightweight material. The hopper has an internal cavity or basin substantially in the shape of an inverted cone, so to funnel a collection of balls or other projectiles downward toward an exit from the hopper. There may be provided a generally tubular feed conduit in communication with the bottom of the basin through which projectiles are fed serially for provision to the impeller. A controllable release mechanism adjacent to the conduit is movable between two positions to regulate the one-by-one movement of projectiles through the conduit.

The impeller preferably is a hollow cylindrical shell, likewise of durable lightweight weatherproof plastic or the like. Within the impeller are a pair of vertically arranged vanes which define the sides of a laterally oriented ejection channel. A central aperture in the top of the impeller permits projectiles to pass from the feed conduit into the ejection channel. The ejection channel has two open ends at diametrically opposite sides of the impeller, from which a ball in the ejection channel may be ejected. The impeller is motor driven, as by the motor in the base, to rotate around a vertical axis. A ball that falls from the hopper through the feed conduit and central aperture arrives in the ejection channel, from either open end of which it is rapidly ejected by the centrifugal effect of the rotating impeller.

A primary object of the present invention is to provide an apparatus that encourages household pets to exercise.

Another object of the invention is to provide an apparatus that will entertain and stimulate household pets, particularly dogs.

A primary advantage of the disclosed apparatus is that it intermittently ejects projectiles, such as balls, in random directions throughout a 360-degree circumference about the apparatus.

Another advantage of the invention is that it can function to exercise and entertain a pet for extended periods of time without being attended or operated by a human user.

Yet another advantage of the apparatus disclosed herein is one of convenience to the pet owner. Pet owners must no longer take time out of their busy day to exercise a pet. For example, if an unforeseen occasion, such as a late business meeting, a traffic jam or such, delays the pet owner lat in the day, the owner can be assured the pet is duly exercised. The owner has no reason to feel that the pet is neglected if walking the pet is not practical or desired.

Another advantage of the present invention is that it is entertaining for the pet owner to watch his or her pet to run, jump and play. Most pet owners enjoy watching a pet run, chase a ball, fetch and retrieve a ball, and the like. The present invention give pet owners the opportunity to watch a pet run and play without the pet owner's having to participate directly in the physical activity—an aspect of the present invention that is particularly appealing to an elderly or physically handicapped pet owner.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1 is a perspective side view of a preferred embodiment of the apparatus of this disclosure;

FIG. 2 is a side elevation, at smaller scale, of the apparatus depicted in FIG. 1, showing by phantom lines certain internal features and elements;

FIG. 3 is a top view of the apparatus seen in FIG. 1;

FIG. 4 is a top view of the impeller component of the apparatus seen in FIG. 1; and

FIG. 5 is a partial side sectional view of an alternative embodiment of the apparatus of this disclosure.

### DESCRIPTION OF THE PREFERRED EMBODIMENTS (BEST MODES FOR CARRYING OUT THE INVENTION)

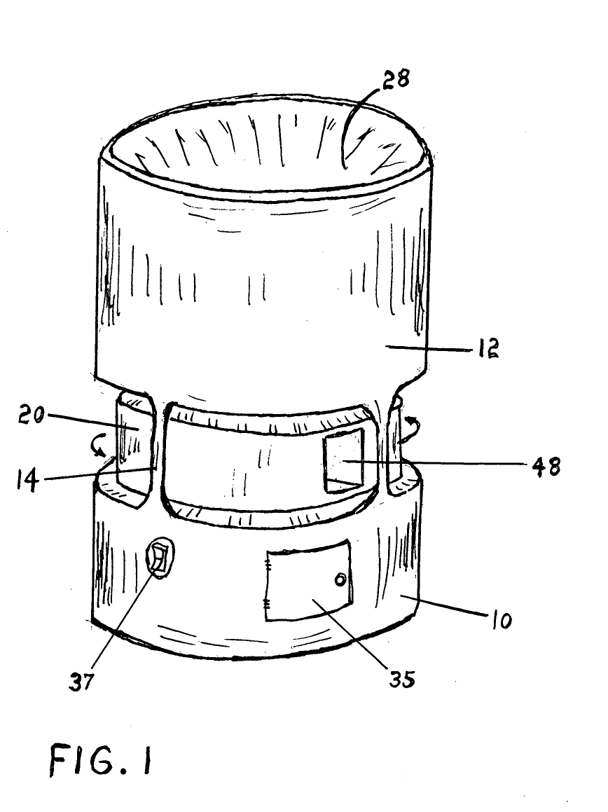

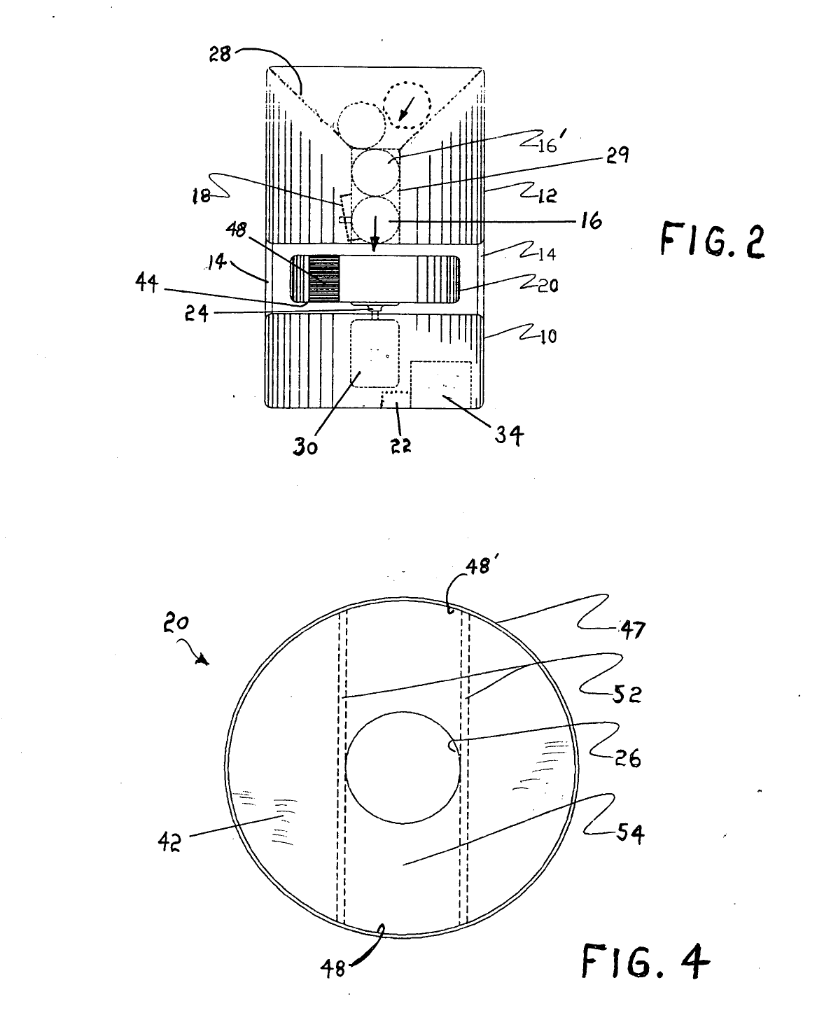

Reference is made to FIGS. 1 and 2, side views of an embodiment of the apparatus. The apparatus includes as principal components a base 10, an impeller 20 and a hopper 12 in vertically stacked relation, and in operational connection in the manners shortly to be described. The overall apparatus may be from one to four feet in height, and preferably has a circular plan profile of about eighteen inches to three feet, but these dimensions are by way of example only and not limitation. The size of the apparatus is suited to the size of the pet(s) to be entertained, smaller apparatuses being preferable for use by cats. The apparatus is contemplated to be lightweight and generally portable.

The base 10 provides the foundational support for the overall apparatus, and also houses elements for the function of the apparatus, including a motor 30 and elements relating to the operation of the motor, including wiring, switching, and a power source 34. The hopper 12 is supported above and in spaced relation from the base 10 by three or more stanchions 14. The impeller 20 is rotatably mounted upon the base 10; rotary power is supplied to the impeller 20 by means of the motor 30. The hopper 12, disposed above the impeller 20, serves to hold projectiles 16, 16′ to be dispensed to the impeller 20 in a manner to be further described. The projectiles 16, 16′ are serially ejected from the impeller 20 during operation of the apparatus.

The base 10 preferably is made from any durable, sturdy material such as molded plastic or lightweight metal alloy. The base 10 can have virtually any shape, but preferably is cylindrical having a flat planar top and a flat bottom. A flat bottom permits the apparatus to be rested firmly upon the ground during operation of the apparatus. As seen in FIGS. 1 and 2, the cylindrical base 10 may have an exterior diameter corresponding generally to the outside diameter of the upper hopper 12, which also preferably but not necessarily is substantially cylindrical. The base 10 is substantially hollow, so to house therein the motor 30, the power source 34 and perhaps other elements. An access door 35 may be provided in the bottom or side (as shown) of the base 10 to permit access to interior components.

Notably, the motor 30 and impeller 20 when actuated emit a mild whirring sound. Thus, in the preferred embodiment where the motor 30 is actuated briefly at intermittent or periodic intervals, the sound of the actuating motor attracts the pet's attention. Thus, the pet learns to recognize the sound of the motor 30 and the incipient motion of the impeller 20 as it begins to rotate, and associates these signals with the imminent ejection of a projectile. The pet animal thereby can anticipate, and be stimulated by, the apparatus in immediate advance of the actual ejection of a projectile to be chased. The whirring sound of the motor 30, and movement of the impeller, cue the animal's attention for ht play that is about to commence. This sound and action increase the animal's attention and interest, as does the unpredictable trajectory of the projectile's flight. The increased anticipation thus helps stimulate the animal at play.

The powered functions of the apparatus, including the release mechanism 18 and the motor 30, receive electrical power from an on-board DC power source 34, such as a battery. A battery power source, such as a rechargeable battery, promotes portability of the apparatus and ready use outdoors. Alternatively, the apparatus may be powered by conventional household 110-Volt 60 Hz, by means of a typical power cord and plug (not shown) electrically connected to the apparatus. In such instances, the base 10 may house conventional electrical components (transformers and the like) for operating the apparatus according to principles known in the art. The circuitry of the apparatus may be tuned off and on by a typical master toggle or other type switch 37.

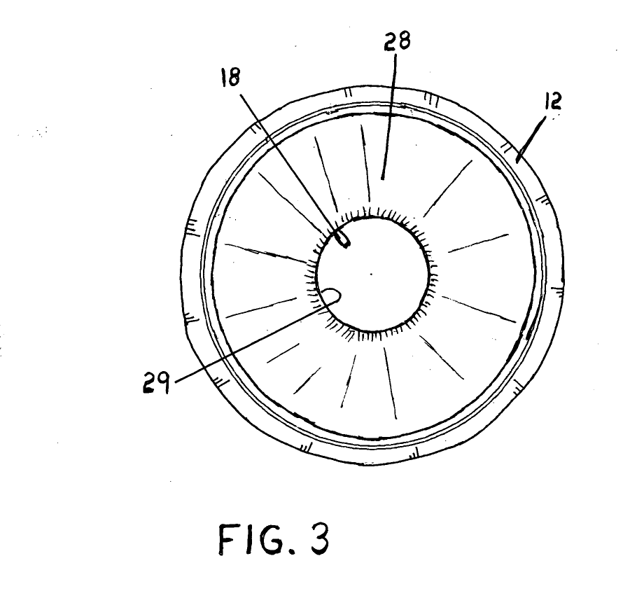

The hopper 12 is fashioned from any suitable substantially rigid material. For example, it may be made from blow- or rotation-molded plastic, or may be assembled from assorted plastic or lightweight metal parts. As seen in FIGS. 1-3, the hopper 12 defines therein a basin 28 for receiving and holding one or more, preferably a plurality, of projectiles 16, 16′ such as spherical balls, for example tennis balls or the like. The basin 28 generally exhibits the contour of an inverted cone, so that projectiles 16, 16′ are urged by gravity toward the bottom of the basin 28 as suggested by the directional arrows of FIG. 2. The bottom of the basin 28 is in communication with a feed conduit 29, which permits projectiles 16, 16′ to drop by gravity (e.g., one at a time) from within the basin into the volume below the basin. Thus, the feed conduit 29, which may be generally tubular with a diameter just slightly greater than the diameters of the projectiles 16, 16′, serves as a via for dispensing projectiles from the basin 28 to the impeller 20.

There is provided in the hopper 12 and in operative adjacency to the conduit 29 a release mechanism 18 devised to controllably interrupt the passage of projectiles 16, 16′ through the feed conduit 29. In one preferred embodiment, the release mechanism 18 is a pivotal chock movable (as by any suitable mechanical means, including by small motor or solenoid) to and fro in relation to a projectile 16 within the feed conduit 29. Mechanism 18 is movable between a closed position and an open position. In the closed position, the mechanism 18 is moved inwardly toward or into the conduit 29 to contact a projectile 16 poised within the conduit. The contact between the mechanism 18 and the projectile 16 next to be dispensed prevents the projectile from falling from the open bottom of the conduit 29. In its “open” position, the mechanism 18 retracts or withdraws slightly away from the conduit 29, thereby disengaging from the projectile 16 and releasing it to fall into the impeller 20. A next one 16′ of the projectiles then shifts downward by gravity, to be held and then released by the release mechanism 18, as the mechanism is periodically (or irregularly) opened and closed. This process is repeated so that a plurality of projectiles disposed in the basin 28 are serially funneled by gravity to the bottom of the basin for movement through the feed conduit 29, until all the supply of projectiles temporarily stored in the hopper 12 has been exhausted by the ejection, one at a time, of projectiles from the apparatus.

Operation of the release mechanism 18 may be by means of a controller 22, shown in FIG. 2 as being housed in the base 10, but which may be situated elsewhere in the apparatus. The controller 22 is powered from power source 34, and is in electrical communication with the release mechanism 18. Controller 22 may be a commercially available electronic timer, of any suitable type known in the art, which may electrically signal the release mechanism 18 to move to and from its open and closed positions at regular, or periodic, or pre-selected time intervals. Thus, the controller 22 may optionally include a digitally programmable feature, whereby the user may select the periodic, or alternatively irregular, movement of the release mechanism 18. The falling of projectiles 16, 16′ through the feed conduit 29 is regulated by the combined functions of the release mechanism 18 and the controller 22, so that projectiles move to the impeller 20 at timed periodic or random irregular, intervals.

Optionally, the controller 22 may be actuated by remote control, as by radio or infrared energy signal, or by means of a lengthy flexible insulated wire, with a hand-held remote control unit (not shown) generally according to known principles and readily available systems known in the art. A radio or infrared receiver mounted on the apparatus thus may receive instructions from the remote control unit, e.g., by the push of a button on the remote control, whereby the user can signal via the controller 22 the opening of the release mechanism 18 to permit the poised projectile 16 to fall from the conduit 29.

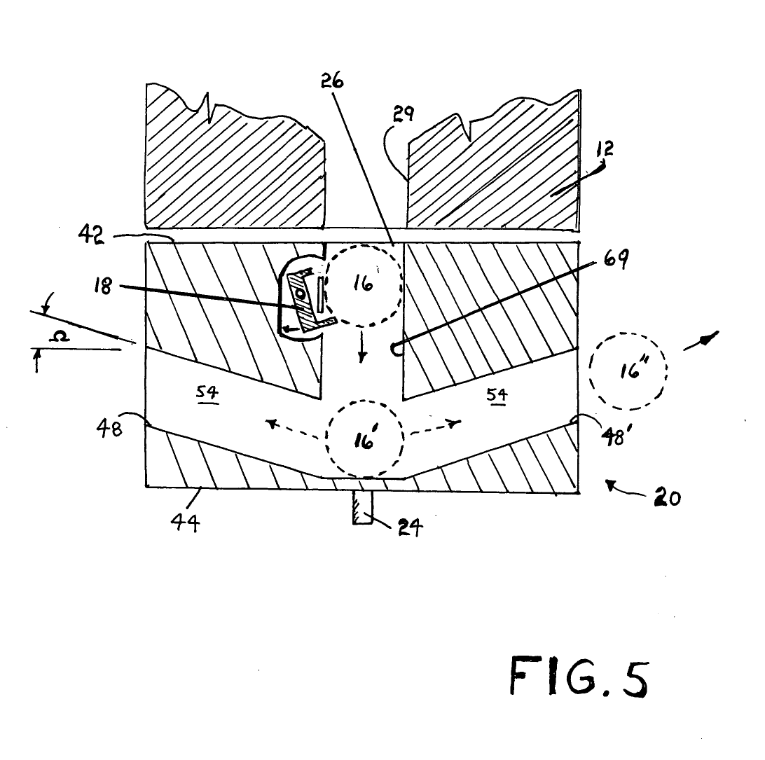

Collective reference is made to FIGS. 1 and 2, and particular attention is invited to FIG. 4, depicting the configuration of the impeller 20. The impeller 20 is the apparatus component which actively flings or throws projectiles from the apparatus, the projectiles to be chased by the pet animal. As best seen in FIG. 2, the impeller 20 is in operative connection to the motor 30. Such connection may be direct, whereby the driveshaft of the motor 30 is connected directly to the center of the bottom of the impeller 20 as indicated in FIG. 2. Alternatively, the connection between the motor 30 and the impeller 22 may be by way of belts, gears, chains, or the like, or combinations thereof, according to known concepts. The impeller 20 rotates by means of a journaled shaft or spindle 24 (which optionally is an extension of the motor's driveshaft) disposed on or through the base 10.

However transmitted, rotary power from the motor 30 drives the impeller 20 to rotate about its central, vertical, axis. The speed of rotation typically is fixed, but in alternative embodiments incorporating a programmable controller 22, may be variable. The speed of rotation is related to the overall size of the apparatus, with larger apparatuses (such as for large dogs) having proportionally slower angular velocities. The impeller's 20 rotary speed is selected to be adequate to generate sufficient centrifugal force upon a projectile within the impeller so as to throw the projectile horizontally from the impeller a substantial distance. Determining and implementing a suitable speed of rotation is within the skill set of a mechanical engineer or technician of ordinary skill in the art, and will depend upon, among other things, the size of the apparatus (and impeller 20), the size and weight of the projectiles 16, 16′, and desired ejection distance. During rotation, the impeller 20 is maintained in the generally horizontal position seen in FIGS. 1 and 2; rotation of impeller occurs while the hopper 12 and the base 10 remain stationary.

FIGS. 1 and 4 show a version of the impeller 20. The impeller 20 preferably is generally cylindrical, having a preferred diameter somewhat less that the diameters of the hopper 12 and base 10, as suggested by FIG. 1. The impeller has a top cover 42 and a bottom 44 that preferably are parallel, planar, disks of equal diameters. The top cover 42 defines a central aperture or ball aperture 26 axially concentric with the impeller's axis of rotation. The aperture 26 has a diameter corresponding generally to the diameter of the feed conduit 29, and is vertically aligned and in registration with the bottom opening of the conduit. Accordingly, a projectile 16 falling or otherwise moving from the feed conduit 29 immediately passes into the aperture 26. The top cover 42 and bottom are joined and held in spaced relation by a pair of parallel impeller vanes 52 disposed perpendicularly and securely between the top cover 42 and the bottom 44. There thus is defined between the planar vanes 52 and the cover 42 and bottom 44 an ejection channel 54 having two open ends 48, 48′. The central or ball aperture 26 is in communication with the interior of the ejection channel 54, so that a projectile 16 falling through the aperture 26 immediately enters the ejection channel 54. Additionally and preferably, there also is provided a circumferential wall 47 rigidly extending between the periphery of the top cover 42 and the periphery of the bottom 44 of the impeller, to promote the structural integrity and rotational balance of the impeller 20. The wall 47 may serve as the sole element that solely joins and spaces the top cover 42 and the bottom 44 in those instances where the vanes 52 may not and need not extend the complete distance between the parallel top cover and the bottom.

Attention is directed to FIG. 5, showing an alternative embodiment of the apparatus in which the release mechanism 18 may be actuated by centrifugal force. In this alternative embodiment, the release mechanism 18 is pivotally disposed in the impeller 20 itself, as is the next projectile or ball 16 to be ejected. The release mechanism is pivotal, in a generally vertical plane, under the influence of gravity. When the impeller is at rest (not rotating), the release mechanism 18 under its own weight rests in the closed position (as suggested in FIG. 5) to block or interrupt the downward passage of the poised ball 16. So, the default or rest position of the pivotal chock or the mechanism 18 is “closed.” When the impeller 20 is activated to rotate (as driven by the motor via the shaft 24), the centrifugal force of rotation causes the bottom or lower portion of the release mechanism 18 to swing radially outward, as indicated by the small directional arrow of FIG. 5. As the impeller 20 rotates, the bottom portion of the mechanism 18 moves out and away from the passage 69, to permit the ball 16 to fall down into the ejection channel 54.

FIG. 5 also illustrates that in one preferred embodiment of the apparatus, the ejection channel 54 is configured to manifest an upward cant or incline proceeding radial outward from the axis of rotation of the impeller 20. The ejection channel 54 has an intermediate portion, at the axis of rotation, that is lower than either of the two open end exits 48. Accordingly, a ball or other projectile released by the mechanism 18 falls first to the position shown in phantom lines at 16′ and then, under the effect of the centrifugal force of the rotating impeller 20, moves up and out either side “ramp” of the ejection channel 54, as suggested by the directional arrows in FIG. 5. The projectile then exists one of the open ends 48, and is thrown clear of the rotating impeller 20 at a slightly upward arc, is indicated by the ball 16″ in FIG. 5.

Thus, a preferred aspect of the ejection channel 54 is that it (or at least its bottom surface) is inclined upward, proceeding outwardly from the center of the impeller, at an angle Q (FIG. 5) of between about 15 degrees and about 25 degrees. This upward cant of each half of the channel 54 permits the horizontal centrifugal force of the rotating impeller 20 to impart an upward vector to the outward ejection motion of the ejected projectile, resulting in a throw of a greater distance away from the apparatus.

In the preferred embodiment, the motor 30 is actuated periodically to throw a projectile for the animal to chase. Stated differently, the impeller does not rotate “full time,” to receive dropping projectiles; rather, the controller 22 turns the motor on and off according to the preferred timing that is programmed by the user. This periodic actuation of the motor 30 conserves battery life for battery-powered embodiments. Preferably, in those embodiments where the release mechanism 18 is powered by a motor and/or electronically actuated, the movement of the release mechanism is coordinated with the actuation of the motor 30, so that the impeller 20 moves and the release mechanism 18 opens at corresponding times. Alternatively but less desirably, especially with AC-powered embodiments, the impeller 20 can rotate constantly while the release mechanism 18 is actuated at the predetermined intervals to drop a projectile to be expelled. Again, however, in the preferred mode of operation, the motor 30 is actuated periodically to rotate the impeller 20, and the release mechanism is actuated by the controller 20 contemporaneously with (or in one embodiment, by the rotation of) the impeller 20.

Accordingly there is disclosed an apparatus for exercising and entertaining a pet animal by ejecting balls 16, 16′ in random directions for an animal to chase or retrieve. In basic configuration, the apparatus features the impeller 20 which is rotatable about a substantially vertical axis, with the impeller defining the central ball aperture 26 in communication with the inclined or horizontally disposed ejection channel 54. The hopper 12 has the basin portion 28 for receiving and holding a plurality of balls 16, 16′ to be dispensed serially through the feed conduit 29 to the ball aperture 26 in the impeller 20. The release mechanism 18 regulates the movement of the balls through the feed conduit 29 to the impeller 20, while the motor 30 rotates the impeller 20 about its vertical axis. Balls 16, 16′ move one at a time by gravity from the hopper 12 through the feed conduit 29 to the impeller 20, at which each ball is randomly ejected, by centrifugal force, horizontally from either open end 48 or 48′ of the ejection channel 54.

The impeller 20 has its top cover 42 through which the central ball aperture 26 is defined, its bottom 44 in operative connection with the motor 30, and the two substantially parallel vanes 52 disposed perpendicularly between the cover and the bottom. Consequently, the cover 42, bottom 44, and vanes 52 define at least in part the ejection channel 54. The top cover 42 and the bottom 44 each preferably but not necessarily is a planar circular disk, and the ejection channel 54 accordingly is defined along a diameter of either of these disks.

The release mechanism 18 is controllably movable between an open position and a closed position, so that when it is in the open position one 16 of the balls is freed to move from the feed conduit 29 toward the central ball aperture 26. When the release mechanism 18 is in the closed position, a next one 16′ of the balls is prevented from moving from the feed conduit toward the aperture 26.

Because the ejection channel 54 has two open ends 48, 48′, after a particular ball 16 has moved through the aperture 26 and into the channel 54, rotary motion of the impeller 20 ejects the ball from either one of the open ends unpredictably, without regard for the rotational position of the impeller 20 relative to the hopper 12 or base 10.

The projectile ejecting force, a centrifugal (centripetal inertia) force, results from the rotation of the impeller 20, so that each ball 16 upon dropping through the aperture 26 into the ejection channel 54 immediately moves from the center of the impeller 20 below the aperture 26, gaining speed as it moves toward a random one of either of the open ends 48, 48′ ultimately to be ejected in a random straight-line direction (relative to the apparatus). The balls 16 thus fly out from the apparatus in a myriad of unpredictable directions, to fall to and roll upon the ground or floor to attract the animal's attention. In chasing and receiving the balls 16 the animal is positively exercised while stimulated and entertained.

Notably, the hopper 12 can be filled with a large number of projectiles, and the releasing mechanism 18 timed to release a projectile at a selected frequency, so that the apparatus can function for extended periods of time without the need for frequent re-filling or other constant attendance by a human operator. Thus, the apparatus is capable of autonomous operation. The controller 22 is programmable to stop or start the motor 30 (and/or in alternative embodiments the release mechanism 18) on a predefined schedule, and/or pre-selected time intervals, therefore constant human operation is not required. In the drawings and in the descriptions above, the ejection channel 54 is characterized as having a generally square cross section defined by a planar top, bottom, and sides, where the channel is essentially a rectilinear duct. It should be immediately understood, however, that the channel 54 can be tubular (with a diameter exceeding the diameters of the projectiles 16 by any suitable amount), or any other cross section through which the projectiles may roll and move under the inertia provided by the impeller 20. Further, while the ejection channel 54 is depicted in a preferred embodiment seen in FIG. 5 as having the upwardly pitched or inclined aspect (resulting in the “V” profile seen in FIG. 5), it is to be understood that simpler alternative embodiments may have an ejection channel 54 that is truly entirely horizontal, where the floor of the ejection channel is essentially parallel to the ground (and the bottom 44 of the impeller 20) throughout its length. As mentioned, pitching the two lateral extensions of the ejection channel 54 at a positive upward tilt allows the apparatus to throw the projectiles further (although requiring a comparatively elevated impeller rotation speed to impel the projectiles to roll or slide up the channel ramps). Still, however, the principal movement vector of the projectiles is horizontal, so that the animal chases a projectile that flies away from the apparatus in a low gentle arc, substantially horizontal in relation to the ground.

Thus, in summary, in one manner of practicing the invention, the apparatus is placed on the ground (or floor), and the basin 28 of the hopper 12 (however it may be shaped) is filled with the desired number of projectiles 16. The apparatus is switched to operate either automatically under the regulation of the controller 22, or alternatively by means of a suitable remote control system. The controller 22 can be set to activate the motor 30 at, for example, 10-minute intervals, whereby the motor runs for approximately (again by way of example) ten seconds per activation, with the human operator not in attendance. Under such a programmed scenario, eighteen projectiles in the hopper 12 would permit the apparatus to run unattended for three hours. Every ten minutes, the controller 22 signals the motor 30 to begin rotating the impeller 20. The sudden motion of the impeller 20, coupled with the sound of the motor 30, attracts the animal's attention. The impeller 20 rotates just long enough (again, say ten to twenty seconds) to generate the centrifugal force necessary (1) to swing the release mechanism 18 from a closed to an open position to permit a projectile to drop into the ejection channel 54, and (2) to roll the projectile ball up either of the inclined halves of the channel to be flung out and away from the apparatus.

As soon as the ejected projectile has been thrown clear of the impeller 20, the controller 22 deactivates the motor 30 to cause the impeller to cease rotating. The pivotal release mechanism 18 swings under the force of its own weight back into a closed position to catch the next projectile moving down the feed conduit 29 into the poised “next” position. The next projectile shifts by gravity into position blocked by the release mechanism 18 and there awaits the next activation of the impeller 20 and release mechanism 18. The process is then ready to be repeated.

A significant advantage of the apparatus is that it propels the projectiles in constantly varying, unexpected and unpredictable directions. The trajectory of any given expelled projectile may be through any point of the 360-degree perimeter of the apparatus. This advantage supplies a unique element of excitement for the pet. The random and unpredictable direction of projectile ejection increases the amusement of the pet, especially a dog which may otherwise learn to anticipate the location and direction of expulsion. Because a projectile may be thrown along a trajectory corresponding to any point of the compass, the pet does not learn to expect, and thus be bored by, projectiles that are repeatedly cast in the same direction (as is the case with many devices known in the art).

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. An apparatus for exercising and entertaining a pet animal, comprising:
a hopper in which at least one projectile may be held;
an impeller rotatably disposed below said hopper, wherein said at least one projectile may fall from said hopper into said impeller; and
means for rotating said impeller;
wherein when said at least one projectile falls into said impeller while said impeller is rotating, said projectile is ejected from the apparatus.

2. An apparatus according to claim 1 wherein said hopper comprises a basin portion for containing said at least one projectile.

3. An apparatus according to claim 2 wherein said basin portion generally defines an inverted cone, and further comprising a feed conduit, in communication with said basin portion, through which said at least one projectile may fall.

4. An apparatus according to claim 1 wherein said impeller comprises a central ball aperture in communication with an ejection channel, wherein projectiles falling from said hopper pass through said ball aperture and into said ejection channel.

5. An apparatus according to claim 4 wherein said impeller further comprises:
a top cover;
a bottom; and
two vanes disposed between said cover and said bottom;
wherein said cover, bottom, and vanes define said ejection channel.

6. An apparatus according to claim 5 wherein said ejection channel has two open ends.

7. An apparatus according to claim 6 wherein said top cover and said bottom each comprises a planar circular disk, and said ejection channel is defined along a diameter of either of said disks.

8. An apparatus according to claim 1 wherein said means for rotating said impeller comprises an electric motor.

9. An apparatus according to claim 1 further comprising a controllable release mechanism for regulating the fall of said projectile from said hopper into said impeller.

10. An apparatus for exercising an animal, comprising:
an impeller rotatable about a substantially vertical axis;
a hopper having a basin portion for receiving and holding a plurality of projectiles to be dispensed by gravity to said impeller; and
powered means for rotating said impeller;
wherein said projectiles fall one at a time from said basin portion into said impeller, and when said impeller is rotating said projectiles are ejected one at a time from said impeller and from said apparatus.

11. An apparatus according to claim 10 wherein said impeller further comprises:
a top cover;
a bottom; and
two substantially parallel vanes disposed perpendicularly between said cover and said bottom;
wherein said cover, bottom, and vanes define an ejection channel.

12. An apparatus according to claim 11 wherein said top cover defines therein a central aperture in communication with said ejection channel, wherein projectiles falling from said hopper pass through said aperture and into said ejection channel.

13. An apparatus according to claim 12 further comprising a feed conduit, in communication with said basin portion and said aperture, through which said projectiles fall.

14. An apparatus according to claim 13 further comprising a controllable release mechanism in said feed conduit for regulating the fall of said projectiles through said conduit.

15. An apparatus for exercising and entertaining a pet animal by ejecting balls in random directions for the animal to chase or retrieve, said apparatus comprising:
an impeller rotatable about a substantially vertical axis, said impeller defining a central ball aperture in communication with a generally horizontally disposed ejection channel;
a hopper having a basin portion for receiving and holding a plurality of balls to be dispensed serially through a feed conduit to said ball aperture in said impeller;
a release mechanism for regulating the movement of said balls through said feed conduit to said impeller; and
a motor to rotate said impeller about the vertical axis;
wherein said balls move by gravity from said hopper through said feed conduit to said impeller, and further wherein balls are randomly ejected by centrifugal force from said ejection channel by the rotation of said impeller.

16. An apparatus according to claim 15 wherein said impeller comprises
a top cover through which said central ball aperture is defined;
a bottom in operative connection with said motor; and
two substantially parallel vanes disposed perpendicularly between said cover and said bottom;
wherein said cover, bottom, and vanes define at least in part said ejection channel.

17. An apparatus according to claim 16 wherein said top cover and said bottom each comprises a planar circular disk, and said ejection channel is defined along a diameter of either of said disks.

18. An apparatus according to claim 17 wherein said release mechanism is controllably movable between an open position and a closed position, wherein when said release mechanism is in the open position a one of said balls is freed to move from said feed conduit toward said central ball aperture, and when said release mechanism is in the closed position a next one of said balls is prevented from moving from said feed conduit toward said central ball aperture.

19. An apparatus according to claim 18 wherein said ejection channel has two open ends, and wherein after a ball has moved through said aperture and into said channel, rotary motion of said impeller ejects said ball from either of said open ends without regard for the rotational position of said impeller relative to said hopper.
